(19) United States
(12) Patent Application Publication
(10) Pub. No.: US 2010/0176694 A1
(43) Pub. Date: Jul. 15, 2010

(54) PIEZOELECTRIC ENERGY CONVERTER HAVING A DOUBLE MEMBRANE

(75) Inventors: Gerald Eckstein, Munchen (DE); Ingo Kühne, Munchen (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Munchen (DE)

(21) Appl. No.: 12/733,509

(22) PCT Filed: Aug. 5, 2008
(86) PCT No.: PCT/EP2008/060285

§ 371 Date: Mar. 4, 2010

(30) Foreign Application Priority Data
Sep. 4, 2007 (DE) 10 2007 041 918.1

(51) Int. Cl. H02N 2/18

(52) U.S. Cl. 310/339

(57) ABSTRACT

A first dynamically deflectable membrane structure has two electrode layers and one piezoelectric layer for converting mechanical capacity into electrical capacity, and vice versa. The first membrane structure is mechanically coupled to extra weight. Mechanical and electrical capacities are provided which reduce a non-linear portion of a resetting force of the membrane structure. A second membrane structure is mechanically counter-coupled to the first membrane structure such that both membrane structures are mechanically biased in opposite directions by the extra weight. In this manner, a linearization of the resetting forces occurs as a function of the membrane deflection. The piezoelectric energy converter can generate an electrical capacity of, for example, 0.4 watts to 10 watts.

### CROSS REFERENCE TO RELATED APPLICATIONS

This application is the U.S. national stage of International Application No. PCT/EP2008/060285 filed Aug. 5, 2008 and claims the benefit thereof. The International Application claims the benefits of German Application No. 10 2007 041 918.1 filed on Sep. 4, 2007, both applications are incorporated by reference herein in their entirety.

### BACKGROUND

Known piezoelectric energy converters having a membrane are able to convert mechanical energy in the form of vibrations, for example, into electric energy. A known piezoelectric energy converter of such type is shown in FIG. 1.

The energy converter is a simple mass-spring system. When the additional mass is deflected owing to an acceleration acting upon it, a corresponding deflection will be transmitted to the membrane structure, which can be regarded as a spring. The piezoelectric layer experiences a mechanical stress condition that results in a charge separation between the electrodes owing to the piezoelectric effect. If an electric load is connected externally between the two electrodes and the piezoelectric membrane is deflected dynamically, an electric current can flow.

A significant property is the membrane structure's intrinsic mechanical behavior. The membrane behaves in a highly non-linear fashion because of its non-linear restoring forces, meaning that the membrane structure produces a highly non-linear mechanical oscillator. The mechanical oscillator can be described by equation 1 below:

m·\ddot{x}+b·\dot{x}+k₁·x+k₃·x³=m·a Equation 1

The corresponding non-linear portion of the restoring force is mathematically represented by k₃·x³. The non-linear portion produces a complex resonance behavior that is disadvantageous for the system. Reference is made in that connection to FIG. 2. On the one hand there are unstable conditions (points A and B) that give rise to an undesired hysteresis. That means that different resonance curves can be expected depending on whether passage through the resonance is from low to high frequencies or vice versa. That makes practical use difficult when the energizing vibration spectra do not exhibit actual frequency stability. On the other hand, the frequency (see point A) at which the maximum electric power output can be obtained is dependent on the amplitude of the acceleration acting from outside.

Known piezoelectric energy converters of membrane design are scarcely known. The phenomenon of non-linearity is not addressed in any detail in scientific approaches. The deflection is so small in the case of known implementations that the non-linear restoring force is negligible. However, small membrane deflections produce only small electric power outputs.

### SUMMARY

An aspect is to provide a piezoelectric energy converter having a first dynamically deflectable membrane structure that has two electrode layers with a piezoelectric layer between them, and serving to convert what are compared with the related art large mechanical powers or energies into high electric outputs or energies in such a way that the non-linear portion of the membrane structure's restoring force will be effectively reduced.

A non-linear dynamic is achieved by counter-coupling two mechanically pre-stressed piezoelectric membranes. FIG. 3 is a schematic showing the counter-coupling of two mechanically pre-stressed springs. The resulting restoring force is hence produced by adding the restoring forces of the individual springs. The non-linear portion of the resulting restoring force is effectively reduced through the resulting restoring force's being produced by adding the restoring forces of the individual springs and through mechanical pre-stressing of the individual springs. FIG. 4 shows that mechanically coupling two membranes causes the restoring force to be linearized so that the frequency response approaches that of a known harmonic oscillator. FIG. 5 shows that hysteresis in the frequency curve is avoided and that the frequency response is independent of the excitation amplitude.

The effect of counter-coupling two piezoelectric membranes is to greatly reduce the spring-mass system's non-linear restoring forces and the following advantages ensue: Hysteresis in the frequency response will be avoided and the frequency curve will be independent of the excitation amplitude of the acceleration.

According to an advantageous embodiment, the second membrane structure likewise has the aforementioned properties of the first membrane structure. That applies especially to the membrane structure's dynamic properties as well as to provisioning of the piezoelectric layer and electrodes. An optional support layer having similar properties can furthermore be produced. Matching the second membrane structure to the first membrane structure is intended to produce a mechanical pre-stressing acting counter to the first membrane structure.

According to a further advantageous embodiment, the additional mass is positioned or arranged between the two membrane structures. The additional mass can in that way be spatially mounted particularly advantageously.

According to a further advantageous embodiment, the distance between the two membrane structures at the greatest extent of the additional mass perpendicular to the two membrane structures or the membrane-layer arrangements is different, with the difference being an order of magnitude particularly in the range of a few micrometers. The two membrane structures can therein be mechanically oppositely pre-stressed both outwardly and inwardly. The membrane structures can therein be pre-stressed inwardly toward the additional mass.

According to a further advantageous embodiment, the distance between the two membrane structures or membrane-layer arrangements is less than the greatest extent of the additional mass perpendicular to the two membrane structures or membrane-layer arrangements. The oppositely acting mechanical pre-stressing can thereby be provided in a particularly simple manner. The forces acting outwardly on the two membrane structures are the same.

According to a further advantageous embodiment, a material recess is embodied by a spacer. The two membrane structures extend in each case along opposite sides of the material recess, which is in particular a wafer recess, and of the spacer. The membrane structures are both secured to the spacer and are spaced apart at a distance corresponding to the that produced by the spacer thickness. That is a particularly compact advantageous design for a piezoelectric energy converter.

According to a further advantageous embodiment, the material recess has at least partially a lateral extent corresponding to the greatest lateral extent of the additional mass in order to avoid lateral movements thereof. Mechanical energy, which is vibrations, for instance, will thereby be converted directly into deflecting of the two membrane structures. Losses due to a lateral movement of the additional mass will be effectively reduced. The lateral extent of the material recess can furthermore exceed the greatest lateral extent of the additional mass.

According to a further advantageous embodiment, the additional mass is a sphere, an ellipsoid, a cuboid, or a cylinder. The additional mass can thereby be matched effectively to a vibration's relevant conditions.

According to a further advantageous embodiment, the membrane structures both have a support layer toward the side of the spacer and of the material recess. The membrane structures are both secured to the spacer by the support layer. The electrode layers and piezoelectric layers can in that way be particularly advantageously optimized in terms of the vibrations respectively requiring to be absorbed, with its being possible to optimize the support layer for supporting the membrane structures.

According to a further advantageous embodiment, an electric power can be tapped from the electrode layers when the first and second membrane structure and the additional mass undergo a dynamic mechanical deflection.

According to a further advantageous embodiment, the piezoelectric energy converter is produced as a microelectromechanical system (MEMS). A microelectromechanical system (MEMS) is a combination of mechanical elements, sensors, actuators, and electronic circuits on a substrate or chip.

The piezoelectric energy converter is suitable particularly for frequency ranges of 1 Hz to 1 kHz, for electric capacity ranges of 0.4 to 10 watts, and for deflection ranges of −1·10⁻⁴ to 1 ·10⁻⁴ meters.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a cross sectional view of an exemplary embodiment of a known piezoelectric energy converter;

FIG. 2 is a graphical representation of the non-linear frequency response of a known piezoelectric energy converter;

FIG. 3 is a schematic view of an exemplary embodiment of a counter-coupling of two non-linear springs;

FIG. 4 is a graphical representation of the restoring forces as a function of the membrane deflection for a single membrane and a counter-coupled double membrane;

FIG. 5 is a graphical representation of the theoretic frequency response of a counter-coupled double membrane;

FIG. 6 is a cross sectional view of an exemplary embodiment of a piezoelectric energy converter.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

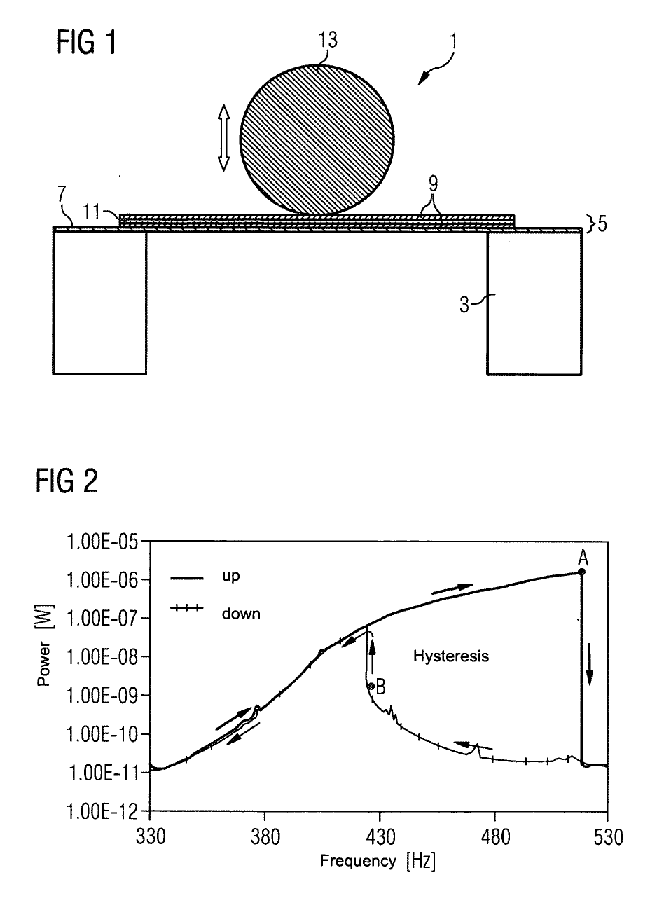

FIG. 1 shows an exemplary embodiment of a known piezoelectric energy converter 1. The energy converter 1 is a simple mass-spring system. A first membrane structure 5 has been produced on a wafer 3 that has been provided in particular as a bulk material. The first membrane structure 5 therein has two electrode layers 9 between which a piezoelectric layer 11 has been produced. All three layers can have been applied directly to the wafer 3 or alternatively produced on a support layer 7 that has been applied to the wafer 3. An additional mass 13 has been mechanically coupled to the first membrane structure 5; the double arrow indicates the acceleration produced by, for example, vibration. The wafer 3 can contain, for example, Si and/or SOI. The electrode layers 9 can contain, for example, Pt, Ti, Pt/Ti. The piezoelectric layer 11 can contain, for example, PZT, AlN, and/or PTFE. The optional support layer 7 can contain, for example, Si, poly-Si, SiO₂, and/or Si₃N₄. The additional mass 13 can contain, for example, metal or have been produced using a plastic material.

FIG. 2 shows the non-linear frequency response of a known energy converter 1 constituted in keeping with FIG. 1, for example. The non-linear portion produces a complex resonance behavior that is disadvantageous for the system. On the one hand there are unstable conditions that are identified by A and B, which gives rise to an undesired hysteresis. The result is that different resonance curves are obtained depending on whether passage through the resonance is from low to high frequencies or vice versa. The energizing vibration spectra do not exhibit frequency stability. The frequency at point A at which the maximum electric power output can be obtained is dependent on the amplitude of the acceleration acting from outside.

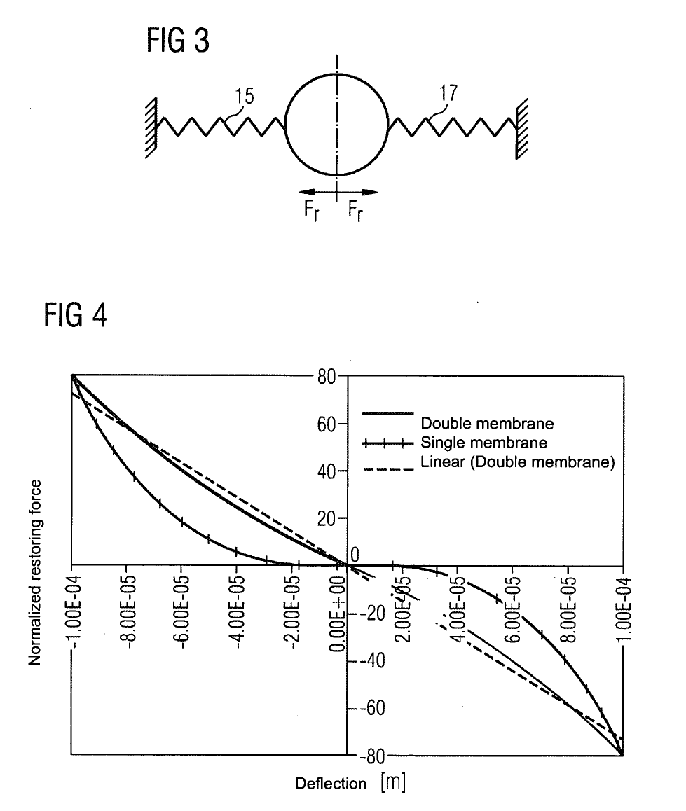

FIG. 3 is a schematic of an exemplary embodiment showing the counter-coupling of two non-linear springs. The resulting restoring force is produced by adding the restoring forces Fᵣ of the individual springs 15 and 17. Both springs 15 and 17 have been mechanically pre-stressed. The restoring forces are identified by the reference letter Fᵣ. Mechanically pre-stressing the individual springs 15 and 17 and adding the restoring forces causes the non-linear portion of the resulting restoring force to be effectively reduced.

A counter-coupling of non-linear springs 15 and 17 as shown in FIG. 3 causes the restoring forces Fᵣ to be linearized as a function of the membrane deflection for mechanically counter-coupled double membranes. Restoring forces of the type are shown in FIG. 4. Mechanically counter-coupling two membranes therefore causes the restoring force Fᵣ to be linearized, which in turn causes the frequency response of an arrangement as shown in FIG. 3 to approach that of a known harmonic oscillator. Shown in FIG. 4 are a single-membrane line, a double-membrane line, and a dashed linearized double-membrane line.

FIG. 5 shows a theoretic frequency response of a mechanically counter-coupled double membrane having a first membrane structure 5 and a second membrane structure 6. Energizing frequencies are in the 0-to-60 Hertz range. A resonant frequency is around 30 Hz, for example.

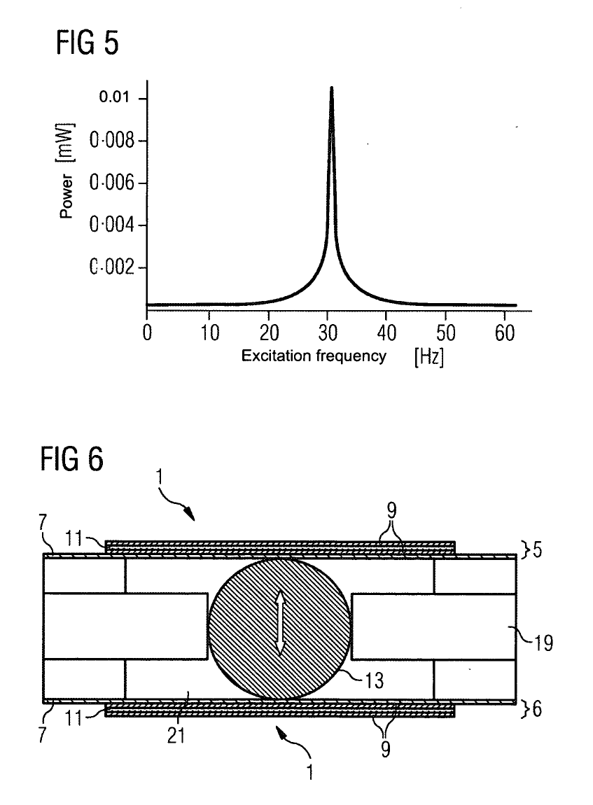

FIG. 6 shows a first exemplary embodiment of a piezoelectric energy converter. Elements that are the same as in FIG. 1 are identified in FIG. 6 with the same reference numerals. Reference numeral 19 identifies a spacer. Reference numeral 21 identifies a recess produced in the spacer 19. According to FIG. 6, two piezoelectric energy converters 1 of membrane design are provided and mechanically counter-coupled. Membrane structures 5 and 6 have both been oppositely mechanically pre-stressed by the additional mass 13. The two individual energy converters 1 have been joined by the spacer 19 of corresponding thickness, specifically through pasting or wafer bonding, for example. The spacer 19 can be, for example, a structured silicon wafer. The additional mass 13 has only been put between the two membrane structures 5 and 6, with the spacer 19 simultaneously preventing a disruptive lateral movement of the additional mass 13. The distance between the two membrane structures 5 and 6 is set such that they will already have been mechanically pre-stressed by the additional mass 13, specifically and in particular by a few meters. Because the distance between the two membrane structures 5 and 6 is less than the greatest extent of the additional mass 13 perpendicular to the two membrane structures 5 and 6, the membrane structures 5 and 6 are both pre-stressed in opposite directions. The restoring forces will in that way be linearized as a function of the membrane deflection of the counter-coupled first and second membrane structure 5 and 6. The materials used for the elements shown in FIG. 6 can correspond to the materials used for the elements shown in FIG. 1. In FIG. 6, a double arrow likewise indicates the directions of the accelerations produced by, for example, vibrations. The additional mass 13 can be, for example, a sphere, an ellipsoid, a cuboid, or a cylinder. Other geometric shapes are also possible. The additional mass 13 can contain a metal, a non-metal, plastic materials, or organic material, for example wood. The additional mass 13 can also have a hollow interior. Other embodiments are also possible. Mechanical coupling of the membrane structures 5 and 6 to the additional mass 13 means that the membrane structures 5 and 6 touch the additional mass 13.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. A piezoelectric energy converter, comprising:
a first dynamically deflectable membrane piezo structure having two electrode structures with a piezoelectric structure therebetween, converting mechanical power into electric power and electric power into mechanical power;
an additional mass mechanically coupled to said first membrane structure; and
a second membrane piezo structure mechanically counter-coupled relative to said first membrane structure so that said first and second membrane piezo structures are mechanically oppositely pre-stressed by said additional mass.

16. The piezoelectric energy converter as claimed in claim 15, wherein the electrode structures and piezoelectric structure have been produced as at least one of layers and bars.

17. The piezoelectric energy converter as claimed in claim 16, wherein the additional mass is arranged between said first and second membrane piezo structures.

18. The piezoelectric energy converter as claimed in claim 17, wherein a distance between said first and second membrane piezo structures at a greatest extent of the additional mass perpendicular to said first and second membrane piezo structures differs by a few μm.

19. The piezoelectric energy converter as claimed in claim 18, wherein the distance between said first and second membrane piezo structures is less than the greatest extent of the additional mass perpendicular to said first and second membrane piezo structures.

20. The piezoelectric energy converter as claimed in claim 19,
further comprising a spacer having a thickness and forming a material recess, and
wherein said first and second membrane piezo structures extend in each case along opposite sides of the material recess, are secured to said spacer, and are spaced apart a distance corresponding to the thickness of the spacer.

21. The piezoelectric energy converter as claimed in claim 20, wherein the material recess has at least partially a lateral extent corresponding substantially to a greatest lateral extent of the additional mass thereby restricting lateral movements of the additional mass.

22. The piezoelectric energy converter as claimed in claim 21, wherein the additional mass is one of a sphere, an ellipsoid, a cuboid and a cylinder.

23. The piezoelectric energy converter as claimed in claim 20, wherein said first and second membrane piezo structures each have a support layer facing said spacer and the material recess and are secured to said spacer by the support layer.

24. The piezoelectric energy converter as claimed in claim 20, wherein the electrode structures supply electric power when said first and second membrane piezo structures and the additional mass undergo a dynamic mechanical deflection.

25. The piezoelectric energy converter as claimed in claim 24, wherein the electric power is supplied in a 1 Hz to 10 KHz frequency range.

26. The piezoelectric energy converter as claimed in claim 24, wherein the electric power is supplied in a 1 Hz to 1 KHz frequency range.

27. The piezoelectric energy converter as claimed in claim 24, wherein the electric power is supplied in a 0 mW to 10 mW electric capacity range

28. The piezoelectric energy converter as claimed in claim 24, wherein the electric power is supplied in a 0.4 μW to 10 μW electric capacity range.

29. The piezoelectric energy converter as claimed in claim 24, wherein deflection of said first and second membrane piezo structures is in a range of 0 mm to 1 mm

30. The piezoelectric energy converter as claimed in claim 24, wherein deflection of said first and second membrane piezo structures is in a range of −1×10⁻⁴ m to 1×10⁻⁴ m.

31. The use of a piezoelectric energy converter as claimed in claim 15, wherein the second membrane structure has a design identical to the first membrane structure.

32. A microelectromechanical system, comprising:
a piezoelectric energy converter formed by
a first dynamically deflectable membrane piezo structure having two electrode structures with a piezoelectric structure therebetween, converting mechanical power into electric power and electric power into mechanical power;
an additional mass mechanically coupled to said first membrane structure; and
a second membrane piezo structure mechanically counter-coupled relative to said first membrane structure so that said first and second membrane piezo structures are mechanically oppositely pre-stressed by said additional mass.
